(19) United States
(12) Patent Application Publication
(10) Pub. No.: US 2007/0283963 A1
(43) Pub. Date: Dec. 13, 2007

(54) Nose air-filter

(76) Inventor: Guadalupe V. Sims, Abilene, TX (US)

Correspondence Address: Galasso & Associates, LP, P.O. Box 26503, Austin, TX, 78755-0503, US

(21) Appl. No.: 11/451,039

(22) Filed: Jun. 12, 2006

(51) Int. Cl. A62B 23/02; A62B 7/10

(52) U.S. Cl. 128/206.18; 128/206.12; 128/205.27

(57) ABSTRACT

Nose Air-Filter consists of a clip for the interior of the nose and two filters connected thereto. The clip is simply attached to a user's septum and the two circular filters are situated just inside a user's nostrils. The user can then breathe normally through the filters without fear of inhaling harmful germs, bacteria, second hand smoke or other deleterious particles.

### CROSS REFERENCE TO RELATED APPLICATIONS

This Non-Provisional Patent Application does not claim priority to any United States provisional application or foreign application.

### FIELD OF THE DISCLOSURE

The disclosures made herein relate generally to an air-filter for humans. The invention discussed herein is in the general classification of health care devices.

### BACKGROUND

Second-hand smoke, germs and bacteria are prevalent in the air and can cause serious problems for humans, including infection, disease and breathing problems. Many individuals are plagued with asthma, making breathing difficult even when they do not encounter foreign air particles. Asthma sufferers often experience an increased level of discomfort when they encounter harmful air-borne particles.

Within a person's home, air filters are used in conjunction with air conditioning systems to reduce the amount of airborne bacteria or other particles within the home. The filters prevent particles from entering the air conditioning unit and then being dispersed through the home. These types of filters also trap particles that would otherwise be floating throughout a home. This is an effective solution, however, air-conditioning filters are useless for protecting a person when he leaves his home.

Various independent air filters can also be purchased without utilizing an air-conditioning system. These independent air filters operate in much the same manner as filters used with air conditioning systems, but these systems are often expensive. Having an additional appliance constantly operating also increases the household energy bill. Again, these filters are of no value to an individual when he leaves his home. This is particularly problematic because an individual is most likely to encounter germs and bacteria when he is in a public forum.

Masks are by far the most common solution for counteracting the dangers associated with breathing unfiltered air in public. Wearing a mask in public is often embarrassing, and many people choose to incur the risks associated with breathing unfiltered air rather than subject themselves to the potential ridicule for wearing a mask.

Hence, there is a need in the art for an aesthetically pleasing, safe, inexpensive mobile and reliable filter system to protect humans from breathing in dangerous airborne particles.

### SUMMARY OF THE DISCLOSURE

Nose Air-Filter consists of a clip for the interior of the nose and two filters connected thereto. The clip is simply attached to a user's septum and the two circular filters are situated inside a user's nostrils. The user can then breathe normally through the filters without fear of inhaling harmful germs and bacteria.

The principal object of this invention is to provide a mobile air filtration device that can be directly clipped to the user.

Another object of this invention is to provide a safe air filtration device.

Another object of this invention is to provide an affordable air filtration device.

Yet another object of this invention is to provide an aesthetically pleasing air filtration device that can be worn in public to reduce inhalation of germs, bacteria and second hand smoke.

### BRIEF DESCRIPTION OF THE DRAWINGS

FIG. 1 depicts a perspective view of the preferred embodiment of the invention.

FIG. 2 depicts an overhead or top view of the preferred embodiment of the invention.

### DETAILED DESCRIPTION OF THE DRAWINGS

The preferred embodiment of Nose Air-Filter is comprised of at least some of the following: a U-shaped clip and a pair of circular rings containing filters attached to the U-shaped clip.

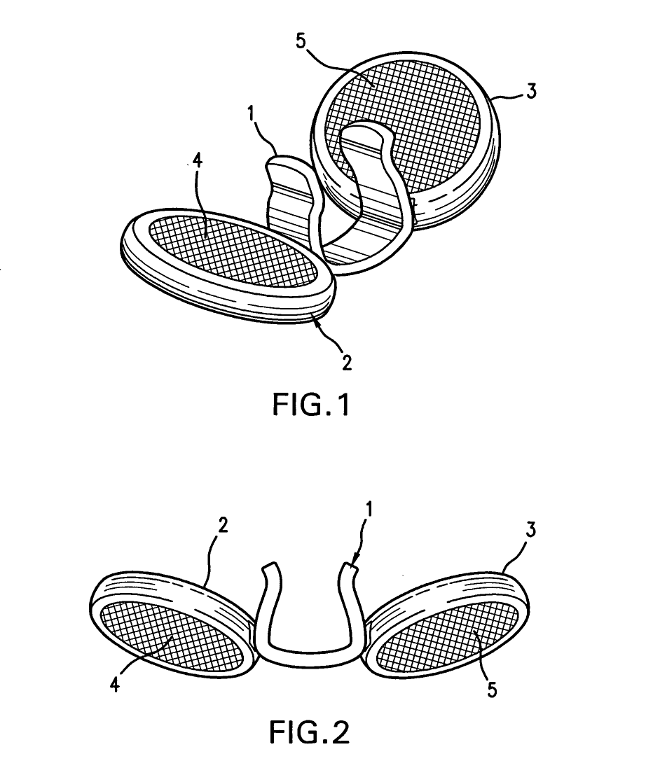

In the preferred embodiment of the invention, shown in FIG. 1, a U-shaped clip 1 attaches on one side to a first ring 2 and on the other side to a second ring 3. The U-shaped clip 1 is made of plastic and is roughly half an inch in length. The first ring 2 and the second ring 3 are also made of plastic. The first ring 2 and the second ring 3 are approximately one half of an inch in diameter and one-eighth of an inch in thickness. A first approximately circular shaped filter 4 is located within the first ring 2. A second approximately circular shaped filter 5 is located within the second ring 3. The first approximately circular shaped filter 4 and second approximately circular shaped filter 5 will be made of materials well known in the art of filter design.

FIG. 2 shows a top view of the preferred embodiment of the invention. The U-shaped clip 1, first ring 2, second ring 3, first approximately circular shaped filter 4 and second approximately circular shaped filter 5 can be seen from this perspective also. The U-shaped clip 1 is more clearly shown in this view and can be seen to be more specifically in the shape of a horseshoe. The U-shaped clip 1 should be flexible enough to fit a variety of individuals.

A user will attach the Nose Air-Filter's U-shaped clip to his septum (the tissue located between the nostrils). Each circular filter will be positioned just inside of each nostril. Once Nose Air-Filter is in place, the user can breathe normally. Intake of germs, bacteria, second hand smoke and other harmful particles will be greatly reduced.

The components of Nose Air-Filter may vary widely but will likely include plastic and possibly metal or other materials.

The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Nose Air-Filter can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the housing and other components of the present invention can be of various shapes and sizes. Ideally, the present invention would have approximately circular rings (housings), however, the term “ring” should not be construed to require a completely circular housing for the filters. Any shape housing for the filters that could be inserted within a user's nostrils are within the scope of the present invention.

It should also be obvious that the components of the invention can be made of different types of plastics or other suitable materials and can be of any color. In addition, the clip can be designed to attach to the septum of the nose, bridge of the nose or other suitable locations. The filters can be of a variety of designs well known in the art. A wire mesh style design is probably the best known in the art, however, any style design will suffice for the present invention.

The present invention could also be modified to include pads on the interior of the clip for comfort in use. For example, rubber or foam pads could be placed on the interior of the U-shaped clip in the preferred embodiment to insure that a user does not experience any discomfort when the device is worn. This could also reduce any irritation that may accompany prolonged use of the device.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. An air-filtration device comprising:
(a) a clip attached to a first ring and to a second ring; and
(b) a first filter within the first ring and a second filter within the second ring.

2. The air-filtration device of claim 1 wherein the clip is made of plastic.

3. The air-filtration device of claim 1 wherein the clip is made of metal.

4. The air-filtration device of claim 1 wherein the clip is U-shaped.

5. The air-filtration device of claim 1 wherein the bottom of the clip attaches to one side of the first ring and one side of the second ring to allow attachment to a user's septum.

6. The air-filtration device of claim 1 wherein the first ring and the second ring are plastic.

7. The air-filtration device of claim 1 wherein the first filter and the second filter are approximately circular.

8. The air-filtration device of claim 1 wherein the first filter and the second filter are made of mesh.

9. The air filtration device of claim 8 wherein the mesh is made of wire.

10. The air-filtration device of claim 1 further comprising at least one pad attached to the clip.

11. An air-filtration device comprising:
(a) a U-shaped clip made of flexible plastic attached to a first ring made of plastic and a second ring made of plastic; and
(b) a first filter that is approximately circular located within the first ring and a second filter that is approximately circular located within the second ring;
(c) said first filter and said second filter being made of wire mesh; and
(d) at least one pad attached to the U-shaped clip.
